(19) United States
(12) Patent Application Publication
(10) Pub. No.: US 2016/0112252 A1
(43) Pub. Date: Apr. 21, 2016

(54) DEPLOYMENT AND UPGRADE OF NETWORK DEVICES IN A NETWORK ENVIRONMENT

(71) Applicant: CISCO TECHNOLOGY, INC., San Jose, CA (US)

(72) Inventor: Jason David Notari, Pleasanton, CA (US)

(73) Assignee: CISCO TECHNOLOGY, INC., San Jose, CA (US)

(21) Appl. No.: 14/515,365

(22) Filed: Oct. 15, 2014

(51) Int. Cl. H04L 12/24; H04L 29/08

(52) U.S. Cl. CPC H04L 41/082; H04L 67/10

(57) ABSTRACT

A method for deployment and upgrade of network devices in a network environment includes comparing configuration settings executing on a switch with settings in a configuration file downloaded to the switch from a central configuration server in the network, identifying a difference between the configuration settings executing on the switch and the settings in the configuration file, synchronizing the difference by updating the configuration file at the configuration server if a sync up operation is selected, and synchronizing the difference by updating the configuration settings executing on the switch if a sync down operation is selected. The sync up operation can comprise updating the configuration file in its entirety; updating a template derived output appended to the configuration file; updating template instance variables feeding into the configuration file; and updating a template used to generate the configuration file.

### TECHNICAL FIELD

This disclosure relates in general to the field of communications and, more particularly, to deployment and upgrade of network devices in a network environment.

### BACKGROUND

Data centers are increasingly used by enterprises for collaboration and for storing data and/or resources. A typical data center network contains myriad network elements, including hosts, load balancers, routers, switches, etc. The network connecting the network elements provides secure user access to data center services and an infrastructure for deployment, interconnection, and aggregation of shared resource as required, including applications, hosts, appliances, and storage. Improving operational efficiency and optimizing utilization of resources in data centers are some of the challenges facing data center managers. Data center managers want a resilient infrastructure that consistently supports diverse applications and services and protects the applications and services against disruptions. A properly planned and operating data center network provides application and data integrity and optimizes application availability and performance. In such data centers and similar networking environments, automation, including in deployment and upgrade of network devices, can enable operational efficiencies.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for deployment and upgrade of network devices in a network environment;

FIG. 2 is a simplified diagram illustrating example details of the system in accordance with one embodiment;

FIG. 3 is a simplified block diagram illustrating further example details of the system in accordance with one embodiment;

FIG. 4 is a simplified block diagram illustrating other example details of the system in accordance with one embodiment;

FIG. 5 is a simplified flow diagram illustrating example operations that may be associated with an embodiment of the system;

FIG. 6 is a simplified flow diagram illustrating further example operations that may be associated with an embodiment of the system;

FIG. 7 is a simplified diagram illustrating yet other example details of the system in accordance with one embodiment; and

FIG. 8 is a simplified flow diagram illustrating further example operations that may be associated with an embodiment of the system.

### DETAILED DESCRIPTION OF EXAMPLE EMBODIMENTS

### Overview

An example method for deployment and upgrade of network devices in a network environment includes comparing configuration settings executing on a switch with settings in a configuration file downloaded to the switch from a central configuration server in the network, identifying a difference between the configuration settings executing on the switch and the settings in the configuration file, synchronizing (e.g., harmonizing, matching, etc.) the difference by updating the configuration file at the configuration server if a sync up operation is selected, and synchronizing the difference by updating the configuration settings executing on the switch if a sync down operation is selected. The sync up operation can comprise updating the configuration file in its entirety; updating a template derived output appended to the configuration file; updating template instance variables feeding into the configuration file; and updating a template used to generate the configuration file.

As used herein, the term “switch” refers to a hardware network element configured to receive, forward, and switch or route packets in a network environment. A typical switch may include a plurality of ports and a switching fabric, generally implemented using an application specific integrated circuit (ASIC) or a network processor. Switch configuration settings can include virtual interface settings, host port lists, Internet Protocol (IP) address, subnet mask, default gateway, virtual local area network (VLANs) on various ports, management interface, interface speed for each port, etc.

### Example Embodiments

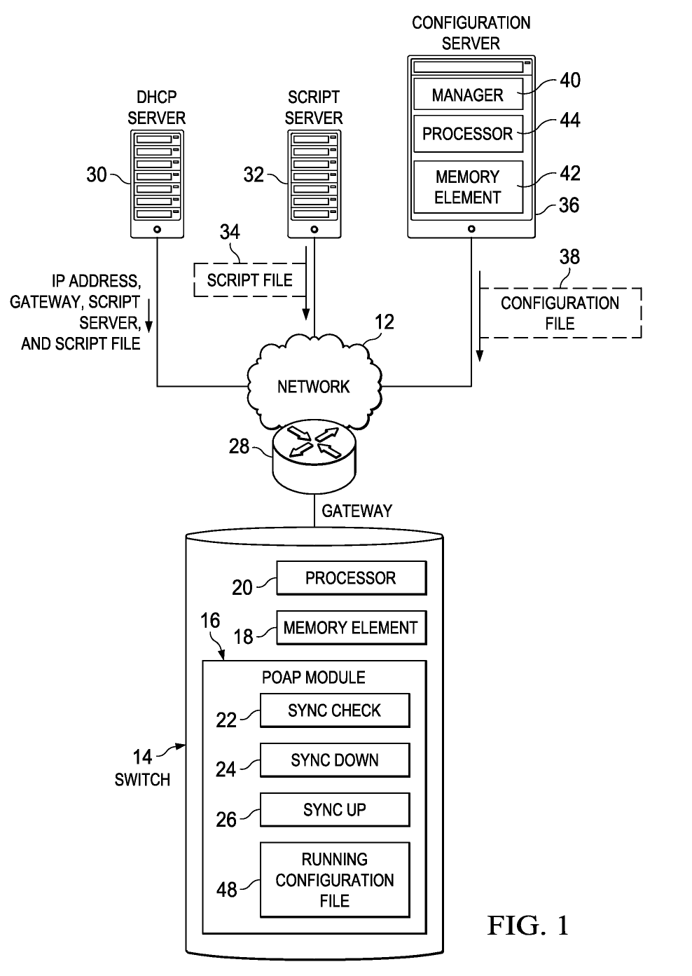

Turning to FIG. 1, FIG. 1 is a simplified block diagram illustrating a communication system 10 for deployment and upgrade of network devices in a network environment. Communication system 10 includes a network 12 (generally indicated by an arrow) comprising a switch 12. As used herein, the term “switch” includes a network element configured to receive, route, and forward packets from various other network elements within a network environment, such as network 12. The term “network element” is meant to encompass computers, network appliances, servers, routers, switches, gateways, bridges, load balancers, firewalls, processors, modules, or any other suitable device, component, element, or object operable to exchange information in the network environment. Moreover, the network elements may include any suitable hardware, software, components, modules, interfaces, or objects that facilitate the operations thereof. This may be inclusive of appropriate algorithms and communication protocols that allow for the effective exchange of data or information.

Switch 14 includes a Power-On-Auto-Provisioning (POAP) module 16, a memory element 18, and a processor 20. POAP module 16 may include a sync check module 22, a sync down module 24 and a sync up module 26 (among other components). Switch 14 may communicate via a gateway (e.g., router, another switch, etc.) 28 with a Dynamic Host Configuration Protocol (DHCP) server 30, from which switch 14 may obtain DHCP information comprising, for example, Internet Protocol (IP) address, gateway identity, script server name, and script file details. Switch 14 may also communicate with a script server 32, from which switch 14 may obtain a script file 34 (e.g., a set of instructions, written in a scripting language, such as Python, Tool Command Language (TCL), etc., such that the set of instructions can be interpreted and executed by processor 20 without compiling). Switch 14 may further communicate with a configuration server 36, from which switch 14 may obtain a configuration file 38. Configuration server 36 may include a manager 40, a memory element 42, and a processor 44 (among other components).

As used herein, the term “configuration file” includes one or more files comprising initial settings for one or more computer programs or network elements, such as switches (e.g., switch 14). The configuration file can be used to set switch processes and switch operating systems. The contents of the configuration file may vary with location (e.g., address, position, relative situation in the network topology, such as leaf, spine, etc.) and identity of the switch being configured, among other factors. In various embodiments, the configuration file may be written in ASCII (or UTF-8) and line-oriented, with lines terminated by a newline or carriage return/line feed pair, depending on the operating system. In other embodiments, the configuration file may be formatted as a simple database.

In some embodiments, configuration file 38 may be generated by a user using appropriate tools (e.g., graphical user interfaces, text editor, etc.) and stored in configuration server 34. Configuration file 38 may be stored in configuration server 36 and downloaded therefrom. Switch 14 may store configuration file 38 locally (e.g., in memory element 18) and read it periodically, for example, when relevant software programs are initiated. In some embodiments, switch 14 may periodically download configuration file 38 to check for changes (e.g., script file 34 may be configured to instruct POAP module 16 to re-read configuration file 38 and apply the changes to currently executing processes). In some embodiments, manager 40 at configuration server 36 may push configuration file 38 to switch 14 upon updates or changes to configuration file 38. In some embodiments, switch 14 may copy the current POAP configuration executing in switch 14 to a running configuration file 48.

According to various embodiments, communication system 10 may provide distributed detection and reconciliation of differences between a centralized controlled device configuration and current network device running configuration. Synchronization can be achieved in two directions through various mechanisms, for example, sync down (e.g., undo out-of-band device configuration changes), sync-up full configuration (e.g., download full configuration file), sync-up delta in configurations (e.g., download change in configuration file since last download), sync-up to template instance variables (e.g., download change in configuration variables), or sync-up to a new template (e.g., download configuration file according to new template).

In various embodiments, communication system 10 provides missing visibility about the current state of managed network 12, and allows network administrators to use tools and access methods of their choice along with centralized management without conflict. It also allows network administrators to take a bottoms up approach to template definition by making changes on a single device (e.g., switch 14); then synchronizing the changes up to a template, and down to other devices, for example, to ensure consistent configuration. It also allows a top down approach where changes made on a configuration controller (e.g., manager 40) are incrementally pushed down to managed devices, such as switch 14.

For purposes of illustrating the techniques of communication system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Typically at first deployment or replacement, network devices such as switches are connected to other network elements, upgraded and configured. The configuration typically depends on several factors, including position (e.g., access, edge, gateway, leaf, spine, etc.), location (e.g., subnet, virtual local area network, etc.), and functionalities (e.g., Top-Of-Rack switch, Local Area Network (LAN) switch, Wide Area Network (WAN) switch, Media Access Control (MAC) filtering, Spanning Tree Protocols, Internet Protocol (IP) clustering, etc.) of the switch in the network. In some network environments, each switch is manually connected, configured and upgraded by the user, such as a system administrator or network administrator. In some other network environments, after initial activation, a portion of the configuration may be remotely managed, for example, through a remote management system; however, the initial activation typically requires manual intervention. In massively scalable data centers, with a large number of switches, such manual process can lead to operational inefficiencies.

Unlike servers, switches typically require complex configuration settings to function appropriately in the network. For example, a Cisco Catalyst 6500 switch may need the following configurations to function appropriately: Router Mode with Multilayer Switch Feature Card (MSFC) on Client Side; Bridged Mode with the MSFC on Client Side; Probe configurations; Source Network Address Translation (NAT) for Server-Originated Connections to virtual IP (VIP) address; Session Persistence (Stickiness) settings; Direct Access to Servers in Router Mode; Server-to-Server Load-Balanced Connections; Route Health Injection; Server Names; Backup Server Farm settings; Load-Balancing Decisions Based on the Source IP Address; Layer 7 Load Balancing; HTTP Redirect; etc. Such configuration settings may vary with the position of the switch in the network and the network topology (among other factors). For example, a switch in a TRILL network may be configured differently from a switch in a ring topology; moreover, a leaf switch in the TRILL network may be differently configured from a spine switch in the same TRILL topology. The automatic download procedures applicable for servers and operating systems of switches typically do not handle such complex configuration scenarios.

In contrast, Cisco's PowerOn Auto Provisioning (POAP) automates the process of upgrading software images and installing configuration files on switches that are being deployed in the network for the first time. POAP uses DHCP to deliver the IP address and server name and file-path to the script file. The script file execution facilitates automatically activating the POAP process in the switch being configured when it boots up. When the switch with the POAP feature boots and does not find a startup configuration, the switch enters POAP mode, locates the DHCP server and bootstraps itself with its interface IP address, gateway, and DNS server IP addresses. It also obtains the IP address of the script server or the URL of the configuration server and downloads the script file.

The script file is executed on the switch to download and install the appropriate configuration file. The script file typically retrieves a switch-specific identifier, for example, the switch's serial number, and downloads the appropriate software image for the switch from the configuration server if the files do not already exist on the switch, schedules the downloaded configuration to be applied at the next switch reboot, and stores the configuration as the startup-configuration. The script file is typically developed using the Python programming language and Tool Command Language (Tcl), and can be customized to meet the network requirements.

The initial POAP process has four phases: (1) power up; (2) DHCP discovery; (3) script execution; and (4) post-installation reload. When the switch is powered up for the first time, it loads the software image installed at manufacturing and tries to find a configuration file from which to boot. When no configuration file is found, POAP mode starts. No user intervention is required for POAP to continue.

During the DHCP discovery phase, the switch sends out DHCP discover messages on all of its active interfaces soliciting DHCP offers from DHCP servers in the network. The DCHP client on the switch uses the switch serial number to identify itself to the DHCP server. The DHCP server can use this identifier to send information, such as the IP address and script file name, back to the DHCP client on the switch. The DHCP discover message also solicits the script server name or address. The DHCP server relays the script server name or address to the DHCP client. The DHCP client uses the supplied information to contact the script server to obtain the script file. When multiple DHCP offers that meet the requirement are received, an offer is randomly chosen. The switch completes the DHCP negotiation (request and acknowledgment) with the selected DHCP server, and the DHCP server assigns an IP address to the switch.

After the switch has bootstrapped itself using the information in the DHCP acknowledgement, the script file is downloaded from the script server. The switch executes the script file, which downloads a switch-specific configuration file from the configuration server (among other applicable files, such as software image for the switch). Subsequently, the switch reboots and applies the settings in the configuration file automatically.

However, POAP does not support provisioning of the switch after it has been configured and is operational. Only auto-provisioning of a switch with no startup configuration is supported. Additionally, the POAP configuration process allows consistent configuration, but at the cost of constant reboots and unknown loss of incremental device changes. Moreover, in a standard network controller paradigm, an individual switch may only receive configuration from a central controller through the configuration server. There are times when it is either not possible—or desirable—to make top-down changes. In such scenarios, the configuration of the individual switch should be replaced to a known managed state; otherwise, it can no longer be effectively controlled.

Some network management products synchronize aspects of device models from currently executing device configuration. Some other network management products periodically archive the startup and/or running configuration of the switch for failure recovery. However, existing network management products do not provide for a managed configuration (e.g., the stored configuration is merely an in-memory configuration model), and do not provide operational managed configuration.

Communication system 10 is configured to address these issues (and others) in offering a system and method for deployment and upgrade of network devices in a network environment. In various embodiments, POAP module 16, using hardware processor 20 to execute instructions stored in memory element 18 of switch 14, compares the configuration settings executing on switch 14 with settings in configuration file 38 downloaded to switch 14 from central configuration server 36 in network 12. In some embodiments, the configuration settings executing on switch 14 are copied to running configuration file 48 for ease of comparison.

In some embodiments, the comparison is performed periodically, for example, according to a predetermined schedule (e.g., as specified in script file 34). In other embodiments, the comparison may be performed upon user command. In yet other embodiments, the comparison may be performed upon instructions from configuration server 36. In yet other embodiments, the comparison may be performed when (and if) configuration server 36 pushes configuration file 38 to switch 14.

Sync check module 22 may identify at least one difference between the configuration settings executing on switch 14 and the settings in configuration file 38. Sync up module 26 may synchronize the difference by updating configuration file 38 at configuration server 36 if a sync up operation is selected (e.g., according to script file 34). If a sync down operation is selected (e.g., according to script file 34), sync down module 26 may synchronize the difference by updating the configuration settings executing on switch 14 to match the settings in configuration file 38. Note that in many embodiments, the selection of the sync down or sync up operation may be according to instructions in script file 34.

In some embodiments, the sync up operation comprises updating a template derived output, called iConfig file, appended to configuration file 38 at configuration server 36. The updated iConfig file may be specific to switch 14, and may not be pushed to other switches in network 12. In some other embodiments, the sync up operation comprises updating template instance variables feeding into configuration file 38 at configuration server 36. In yet other embodiments, the sync up operation comprises updating a template used to generate configuration file 38 at configuration server 36. For example, a new template may be generated at switch 14 based on the configuration settings executing on switch 14; the new template may be pushed to configuration server 36; the existing template at configuration server 26 may be deleted and replaced with the new template. In many embodiments, updated configuration file 38 according to the sync up operation may be pushed to other switches in network 12.

In a general sense, using template based POAP process, a user could deploy or re-deploy large numbers of consistently configured switches quickly and easily in network 12. Thus, POAP is an effective “day zero” configuration tool. However, whereas the configurations can be consistently updated at configuration server 36, actual updates on switch 14 (and other such switches in network 12) would require both erasing and reloading switch 14 (and other such switches in network 12). Applying changes by such repeated erasing and reloading may be possible; however, necessary configuration changes made on switch 14 since the initial (or previous) boot can be lost. Additional time may also be spent during switch reload and booting, increasing the risk of data loss and loss of redundancy in network 12.

Many switches have the rollback capability that generates a configuration differential for atomic configuration changes. Embodiments of communication system 10 may leverage such rollback capability and enhance the configuration updating process in several ways. In some embodiments, sync check module 22 may periodically check configuration synchronization status. In some embodiments, sync check module 22 may periodically compare running configuration file 48 with downloaded configuration file 38.

Differences may exist between running configuration file 48 (which includes the current configuration settings executing on switch 14) and configuration file 38 if configuration changes were made (e.g., manually) at switch 14, or configuration file 38 was updated at configuration server 36 since the last download. A first set of differences, called herein as a first configuration differential, may exist if changes were made to the current configuration executing on switch 14. Thus the first configuration differential includes changes in running configuration file 48 that cannot be found (or that are different from settings) in configuration file 38. A second set of differences, called herein as a second configuration differential, may exist if changes were made to configuration file 38 at configuration server 36. Thus, the second configuration differential includes changes in configuration file 38 that cannot be found (or that are different from settings) in running configuration file 48.

Comparing running configuration file 48 with configuration file 38 individually on each switch in network 12 in a distributed fashion can be effective use of resources. For example, in contrast with the distributed mode of computing the configuration differentials at each switch, a centralized computation would require central manager 40 to be aware of the hardware and specific models of each switch in network 12, which can be inefficient.

In various embodiments, a sync down process can apply the second configuration differential to switch 14 (e.g., roll back out-of-band-changes); a sync up process can update configuration file 38 at configuration server 36 to running configuration file 48. The sync up and sync down can be a complex inverse of each other, for example, the complexity arising from inter-command dependencies. In various embodiments, sync down module 24 may applying the second set of differentials onto switch 14. Thereafter (assuming no other changes have been made), sync check module 22 may re-run the comparison and switch 14 may be in-sync (e.g., synchronized) with configurations specified in configuration file 38. Note that because there is no assumption that switch 14 is in-sync in regard to its configurations, additional changes, or errors could result in switch 14 being unsynchronized (e.g., ‘out-of-sync’) automatically, which brings the issue to the attention of network administrators without having to look through logs or audits to identify a problem.

In various embodiments, sync up module 26 may update configuration settings at configuration server 36 in various ways. In some embodiments, when a user has uploaded a configuration directly to switch 14, a sync-up can be done by updating configuration file 38 stored on configuration server 36, for example, through a ‘copy running poap-config’ in script file 34. In other embodiments, sync up module 26 may generate an iConfig file including the first configuration differential (e.g., changes made to running configuration file 48 that does not exist in configuration file 38) and append the iConfig file to the end of a configuration file 38 at configuration server 36. Such iConfig file may be specific to switch 14 and may differ between switches in network 12. Thus, the iConfig file captures individual switch configuration changes to save them across reloads, but may not be useful for re-application throughout network 12. In such embodiments, manager 40 may not push the iConfig file to other switches in network 12.

In yet other embodiments, sync up module 26 may update template instance variables at configuration server 36 to result in an updated configuration file 38 that accounts for the second configuration differential (e.g., the updated configuration file 38 would include the configuration settings in the second configuration differential). Such variable updates may be performed if the second configuration differential only includes changes to values of variables, and not to the other aspects of the configuration. An example of updating the variables is updating a host port list. In yet other embodiments, sync up module 26 may generate a new template for configuration file 38, which can be used to generate configuration files for numerous switches in network 12. Such a mechanism may be used during a configuration test stage, for example, where a specific configuration is applied to switch 14 and it is desired to propagate the specific configuration to certain other switches in network 12.

Embodiments of communication system 10 may perform distributed detection and reconciliation of differences on switch 14 for scale and model simplicity. Distribution of processing for scale can prevent a centralized controller becoming a bottleneck in fairly large networks. Model simplicity enables a single switch (e.g., running a single version of software) to maintain a single model, which can be understood to generate the first and second configuration differentials. On the other hand, a centralized controller would need to maintain a large matrix of hardware (and hardware combinations) and/or software versions (including enabled features) of different models of switches. Such complexity would by necessity not be able to be complete or arguably accurate enough to generate differentials on a broad range of switches.

Note that script file 34 may include automated instructions relevant to location and identity of switch 14. Script file 34 may be pre-configured by the user (e.g., system administrator, network administrator, etc.) before download by switch 14. Pre-configuration can include specifying various relevant information, such as: the filenames and locations of configuration file 38; method of downloading configuration file 38; local storage location and naming conventions on switch 14; configuration process; software upgrade process; and various other POAP process settings. In various embodiments, the sync up and/or sync down processes may be specified in script file 34. Accordingly, sync down module 24 and sync up module 26 may execute relevant portions of script file 34.

Turning to the infrastructure of communication system 10, the network topology can include any number of servers, gateways, switches, and other network elements inter-connected to form a large and complex network 12. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs. Communication system 10 may include a configuration capable of transmission control protocol/Internet protocol (TCP/IP) communications for the electronic transmission or reception of data packets in a network. Communication system 10 may also operate in conjunction with a User Datagram Protocol/Internet Protocol (UDP/IP) or any other suitable protocol, where appropriate and based on particular needs.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, DHCP server 30, script server 32 and configuration server 36 may be implemented in a single physical network element, for example, as separate virtual machines, server applications, etc. In other embodiments, one or more of DHCP server 30, script server 32 and configuration server 36 may be implemented in separate physical network elements, communicating with each other over physically distinct communication links. Gateway 28 may be a suitable router, or switch, configured to forward data from one network element to another. In some embodiments, manager 40 may comprise a management or controller application executing in configuration server 36; in other embodiments, manager 40 may comprise a management or controller application executing in another network element coupled to configuration server 36 over network 12.

In some embodiments, DHCP server 30, script server 32 and configuration server 36 (including manager 40) may be co-located with switch 14 in a single enterprise network, in which case, router 28 may not be present in the various communication paths. In other embodiments, one or more of the network elements of FIG. 1 may be located at disparate networks separated by network boundaries, in which scenario one or more gateway routers may be included in the communication paths within the broad scope of the embodiments.

In various embodiments, POAP module 16 may comprise an application or portion thereof installed on switch 14 during manufacturing, or after manufacturing and before activation of switch 14 in network 12. An “application” as used herein this Specification, can be inclusive of an executable file comprising instructions that can be understood and processed on a computer, and may further include library modules loaded during execution, object files, system files, hardware logic, software logic, or any other executable modules. POAP module 16 may include a DHCP client and other functionalities for performing the operations described herein.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that the communication system 10 shown in FIG. 1 is simplified for ease of illustration.

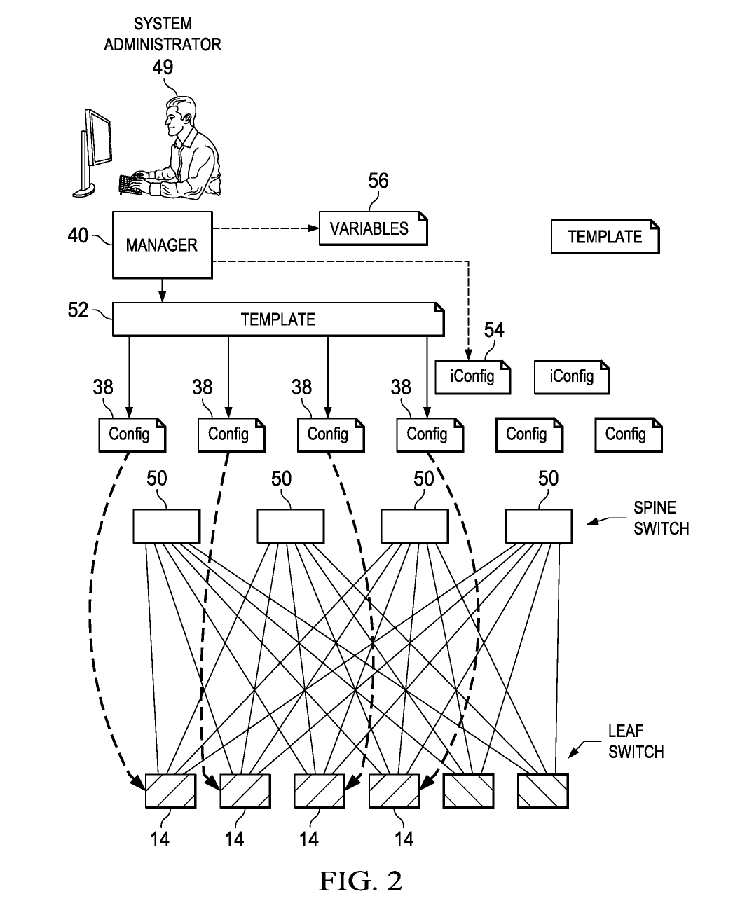

Turning to FIG. 2, FIG. 2 is a simplified diagram illustrating an example sync down process according to an embodiment of communication system 10. A system administrator 49 (e.g., human operator) may cause generation of configuration file 38 at manager 40. Assume, merely for example purposes, and not as a limitation, that switches 14 are coupled to each other through spine switches 50 in a two-tier fat tree network topology, switches 14 forming a leaf switch tier in network 12. Spine switch(es) 50 and leaf switches 14 may comprise identical or similar network elements, and may differ merely in the nature of devices attached to their respective ports: whereas spine switch(es) 50 connect with leaf switches 14 on their respective ports, a plurality of servers (e.g., end hosts) may be connected to leaf switches 14 on their respective ports. Note that any suitable network topology or architecture may be used within the broad scope of the embodiments. In many embodiments, DHCP server 30, script server 32, and configuration server 36 may be coupled to one or more of leaf switches 14 in network 12.

System administrator 49 may create a template 52 comprising configuration parameters for leaf switches 14. In a general sense, template 52 comprises a generic configuration that can be applied to more than one switch in network 12. Template 52 may also be used when a new network branch and common configurations on various switches in the new branch are to be set up quickly and accurately. Furthermore, altering configurations across a large number of switches can be tedious and time-consuming, and template 52 can save time by applying the necessary configurations to various configuration files 38 and ensuring consistency across switches 14.

Template 52 can be a user-defined template that can be custom tailored to the user's desired parameters; such template 52 can generate output which would be accepted via a device command line interface (CLI). CLI templates can allow choosing parameters for configuration file 38 that are generic across various switches 14 in network 12. Device-specific parameters and logic statements may be specified in an iConfig file 54. iConfig file 54 may be appended to template 52 to generate configuration file 38 specific to a particular one of switches 14. For example, iConfig file 54 may include specific features and/or technologies in a particular switch's configuration. Values of variables (e.g., parameterized elements such as IP address, host port list, database type, etc.) may be specified in a variables file 56. In some embodiments, two or more templates may be grouped together into one template. After template 52 is published (e.g., generated, created, finalized, etc.), devices, values, and scheduling information may be specified to tailor the configuration deployment.

In various embodiments, one or more of switches 14 may perform a comparison of their running configuration settings with configuration file 38. If a difference is detected, switch 14 may inform manager 40. Manager 40 may push (e.g., deploy) configuration file 38 to switch 14, which may install configuration settings specified in configuration file 38 on switch 14. In some embodiments, the difference may arise because system administrator 49, through manager 40, has updated configuration file 38, template 52, iConfig file 54 and/or variables file 56. In some embodiments, such updates may trigger a comparison operation at switches 14. In other embodiments, system administrator 49 may force a deployment of the update to switches 14. In yet other embodiments, the comparison may be performed on a routine basis, and the updates identified accordingly.

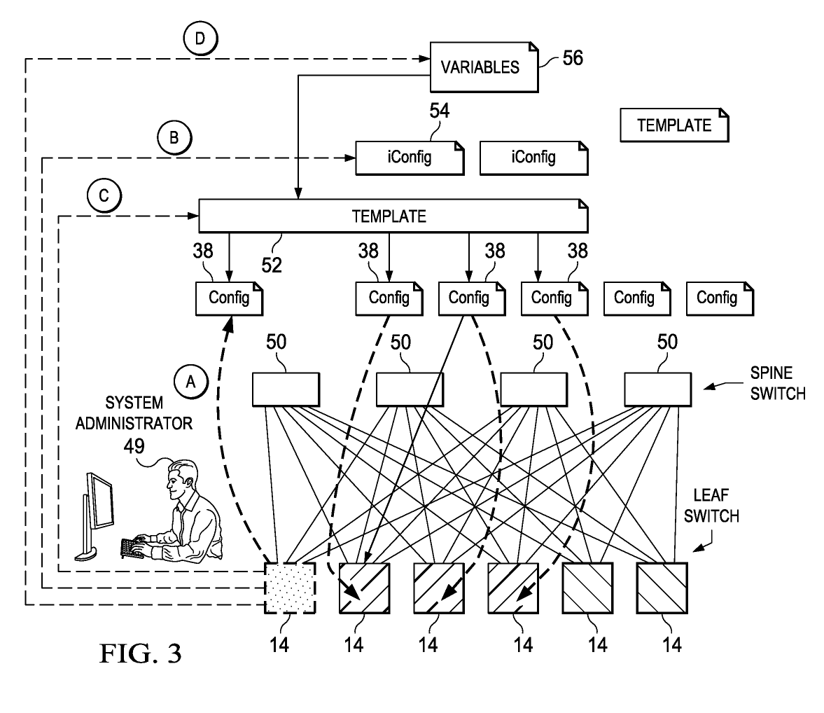

Turning to FIG. 3, FIG. 3 is a simplified diagram illustrating example sync up processes according to an embodiment of communication system 10. System administrator 49 may update configuration settings executing on switch 14. Switch 14 may perform a comparison of configuration settings executing on switch 14 with configuration file 38 and detect a difference, triggering a sync up operation according to script file 34 (or user command). In some embodiments (e.g., as indicated by A), switch 14 may cause an update of configuration file 38 in its entirety. Such update may trigger a propagation by manager 40 of the updates to template 52. An update in template 52 may cause a corresponding update in substantially all configuration files 38 derived from template 52. The update in configuration file 38 may in turn trigger an update of configuration settings in other switches 14 whose configuration settings are based on template 52. For example, switches 14 may notice (e.g., through an Extensible Messaging and Presence Protocol (XMPP) check) that their respective running configurations are out of sync with configuration file 38. Thus, a change in a particular switch 14 may be propagated to other switches 14 through a sync up operation followed by one or more sync down operations.

In other embodiments (e.g., as indicated by B), switch 14 may cause an update of corresponding iConfig file 54. In such embodiments, such change may not trigger an update of template 52 and consequently other configuration files 38. Thus, only configuration settings of a particular one of switches 14 may be changed without affecting configuration settings on other switches 14.

In yet other embodiments (e.g., as indicated by C), switch 14 may cause an update of template 52. For example, system administrator 49 may generate an entirely new template at switch 14 based on the configuration settings executing at switch 14. In another example, changes made to the configuration settings of switch 14 may trigger generation of a new template based on the changed configuration settings. Updated template 52 may be sent to manager 40. Updated template 52 may cause a corresponding update in substantially all configuration files 38 derived from template 52. The update in configuration files 38 may in turn trigger an update of configuration settings in other switches 14 whose configuration settings are based on template 52.

In yet other embodiments (e.g., as indicated by D), switch 14 may cause an update of variables file 56. The change in variables file 56 may trigger a change in template 52 or configuration files 38 appropriately. For example, changes to certain variables may trigger an update of template 52; changes to certain other variables may trigger an update of configuration files 38 derived from template 52 and variables file 56. The update in configuration files 38 (either directly, or through update of template 52) may in turn trigger an update of configuration settings in other switches 14 whose configuration settings are based on template 52.

Note that in many embodiments, the sync down process may be achieved by manual intervention (e.g., system administrator 49 causing update of template 52, or iConfig file 54, or Variables file 56 based on differences with running configuration at switch 14). In other embodiments, the sync down process may be script driven (e.g., with one or more suitable commands).

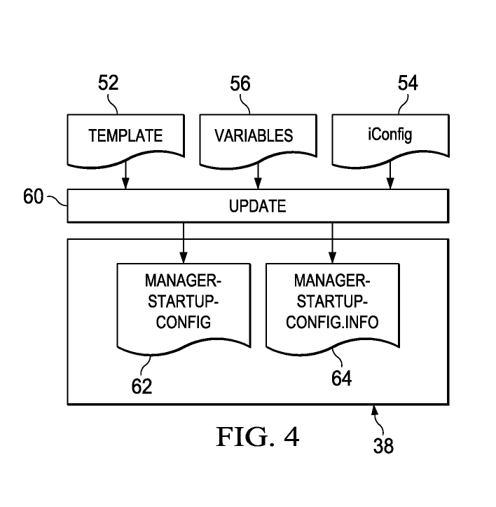

Turning to FIG. 4, FIG. 4 is a simplified block diagram illustrating example details according to an embodiment of communication system 10. Any update 60 to template 52, variables file 56 and iConfig file 54 can update configuration file 38. In various embodiments, configuration file 38 can include two components: (1) a manager startup-config file 62; and a manager startup config.info file 64 (e.g., comprising meta-data of manager startup-config file 62). Template 52 includes a variabalized configuration file with control structures. iConfig file 54 includes a snippet of device specific direct configuration, which could be in a POAP situation, or could be a full configuration in a situation where template 52 does not exist (e.g., each switch 14 has specific, unique configuration). Variables file 56 includes the structure of each variable in template 52 and values thereof. Manager startup config and manager startup config.info file 64 may be generated per switch 14 whenever there is an update to template 52, iCOnfig file 56 and/or variables file 54.

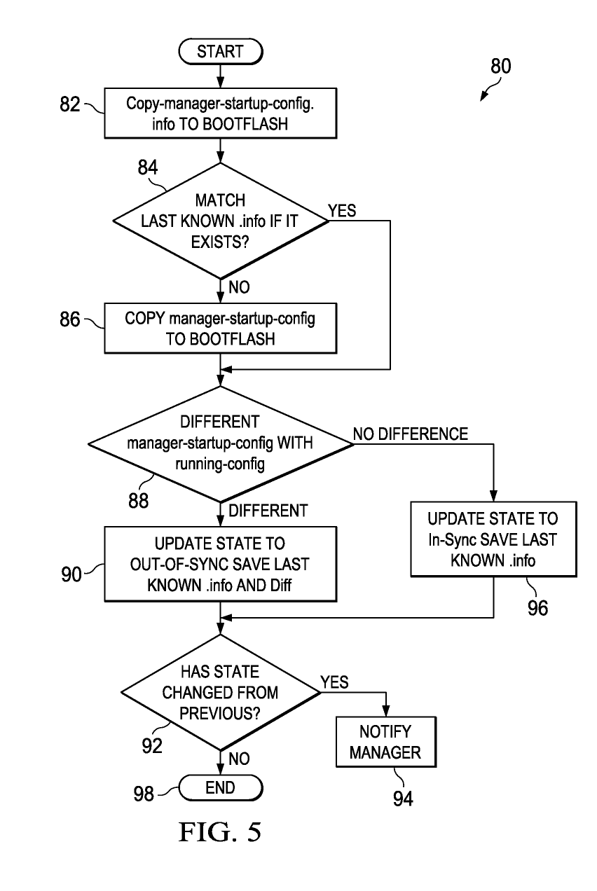

Turning to FIG. 5, FIG. 5 is a simplified flow diagram illustrating example operations 80 of a baseline functionality (e.g., without the sync up or sync down operations) according to an embodiment of communication system 10. Switch 14 may periodically download (if needed) manager startup-config file 62 and generate a differential between the current running configuration and manager startup config file 62. At 82, switch 14 may copy manager startup-config.info file 64 from configuration file 36 into a bootflash (e.g., memory element used for bootup of switch 14) in switch 14. At 84, POAP module 16 may compare manager startup-config.info file 64 with a last know .info file, if it exists. If the .info file does not exist (e.g., a match is not found between the downloaded .info file and .info file stored locally in switch 14), switch 14 may copy manager startup-config file 62 from configuration file 36 into the bootflash. At 88, POAP module 16 may compare manager startup-config file 62 with running configuration file 48. Turning back to 84, if the .info file exists (e.g., a match is found between the downloaded .info file and .info file stored locally in switch 14), the operations may step to 88, at which the comparison with the running configuration is performed.

At 90, if the comparison at 88 indicates a difference, POAP module 16 may update state of switch 14 to out-of-sync save with last known .info and the difference. In other words, the state of switch 14 may be updated to indicate an out-of-sync status. At 92, a determination may be made if the state has changed from a previous state (e.g., from when the status check was last performed). If the state has changed, at 94, manager 40 may be notified. Turning back to 88, if the comparison at 88 indicates no difference between the downloaded configuration file (e.g., manager startup config file 62) and running configuration (e.g., as embodied in running configuration file 48), at 96, the state may be updated to indicate in-sync status since the last known .info file. In other words, the state of switch 14 may be updated (if needed) to indicate in-sync status. The operations may step to 92. At 92, if the state has not changed from the previous state, at 98, the operations may end. Note that the operations may be performed periodically, for example, according to a predetermined schedule.

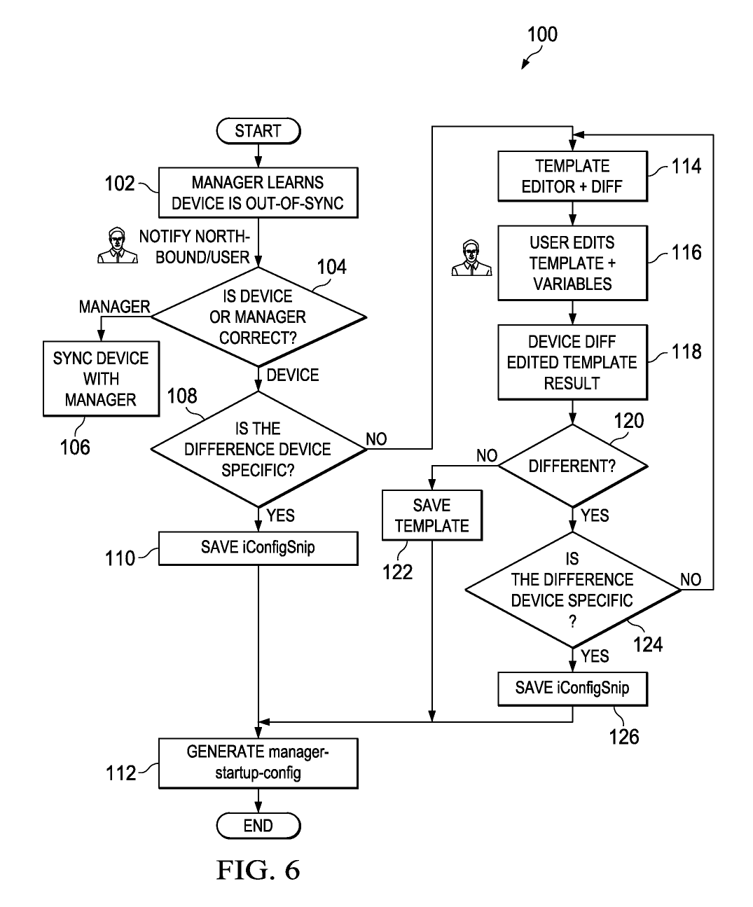

Turning to FIG. 6, FIG. 6 is a simplified flow diagram illustrating example operations 100 indicating an example sync down operation followed by an example sync up operations according to an embodiment of communication system 10. At 102, manager 40 may learn that specific one (or more) switch(es) 14 (e.g., devices) is out of sync. At 104, a determination may be made whether switch 14 or manager 40 is correct (e.g., correctness in such cases may be based on priority and/or other parameters for example, as specified in script file 34). If manager 40 is correct, a sync down operation may be performed at 106, synchronizing configurations executing at switch 14 with configuration file 38 downloaded from manager 40. On the other hand, if switch 14 is correct, at 108 a determination may be made whether the difference causing the out of sync status is device specific. If the difference is device specific, at 110, the difference may be saved into iConfig file 54 snippet. At 112, the update to iConfig file 54 may cause an updated configuration file 38 to be generated (e.g., with generation of manager startup config file 62).

Turning back to 108, if the difference is not device specific, at 114, a template editor and the difference may be identified and brought forth (e.g., on an appropriate graphical user interface, or command line interface, or application programming interface, as the case may be). At 116, system administrator 49 (e.g., user) may edit template 52 and/or Variables file 56 appropriately, based on the difference. At 118, a device differential edited template 52 may result. At 120, a determination may be made whether the new template is different from the running configuration at switch 14. If not, template 52 may be saved at 122, and the operations may step to 112, at which updated configuration file 38 is generated. On the other hand, at 120, if the new template is different from the running configuration at switch 14, at 124, a determination may be made whether the difference is device specific; if so, the difference may be saved to iConfig file 54 at 126, which in turn may cause an updated configuration file 38 to be generated at 112. On the other hand, if the difference is not device specific, the operations may step to 114, and continue thereafter.

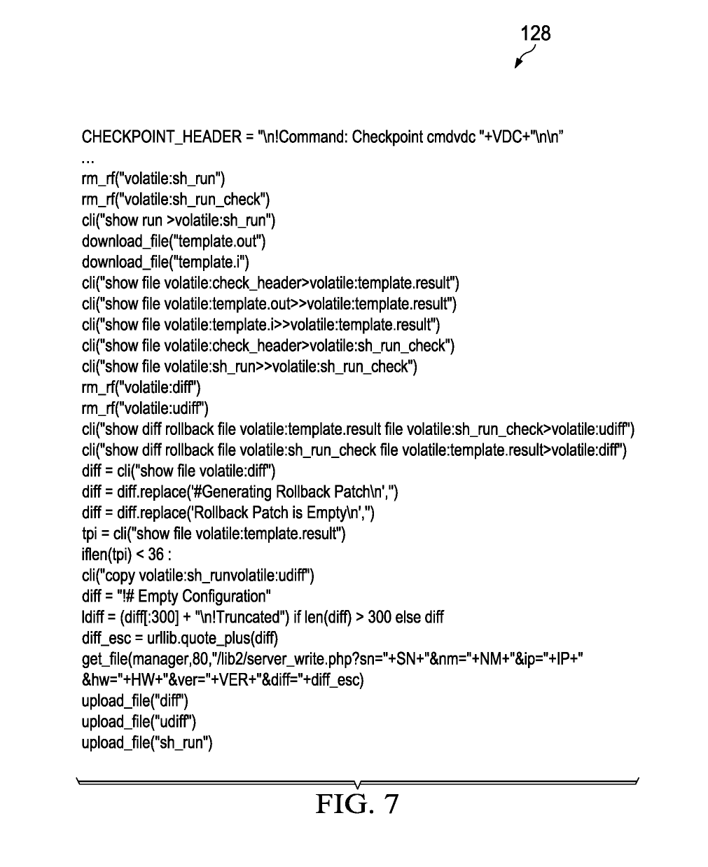

Turning to FIG. 7, FIG. 7 is a simplified diagram illustrating an example script 128 for checking device configurations according to an embodiment of communication system 10. Example script 128 is in Python script, but could be generated in any other suitable computer programming language according to various embodiments. Script 128 may be included in script file 34 in some embodiments. In other embodiments, script 128 may be a stand-alone script stored locally in each switch 14, and that may be executed periodically according to a predetermined schedule.

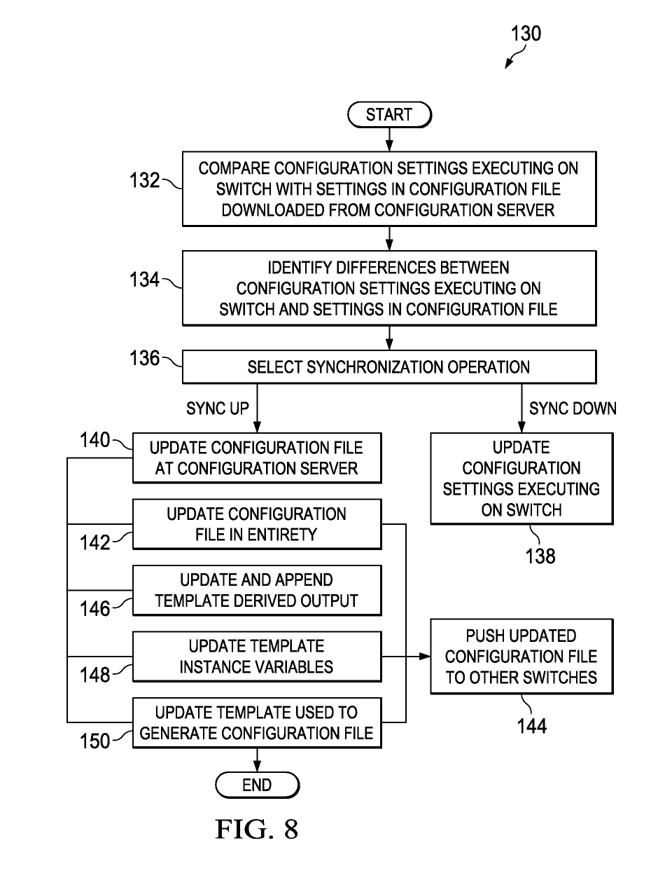

Turning to FIG. 8, FIG. 8 is a simplified flow diagram illustrating example operations 130 that may be associated with embodiments of communication system 10. At 132, POAP module in switch 14 may compare configuration settings executing on switch 14 with settings in configuration file 38 downloaded from configuration server 36. At 134, POAP module 16 may identify differences between configuration settings executing on switch 14 with settings in configuration file 38 downloaded from configuration server 36. At 136, POAP module 16 may select a synchronization operation (e.g., according to script file 34, or user specifications).

If a sync up operation is selected, at 140, configuration file 38 may be updated at configuration server 36. The updating may be according to one or more operations. For example, at 142, configuration file 38 may be updated in its entirety. Thereafter, at 144, manager 40 (or other switches) may push updated configuration file 38 to other switches. In another example, the updating may comprise updating an appending a template derived output in the form of iConfig file 54 at 146. Updating iConfig file 54 may not result in a push of the update to other switches in network 12. In yet another example, the updating may comprise updating template instance variables file 56 at 148. Thereafter, at 144, manager 40 (or other switches) may push updated configuration file 38 to other switches. In yet another example, the updating may comprise updating template 52 used to generate configuration file 38. Thereafter, at 144, manager 40 (or other switches) may push updated configuration file 38 to other switches.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In example implementations, at least some portions of the activities outlined herein may be implemented in software in, for example, POAP module 16. In some embodiments, one or more of these features may be implemented in hardware, provided external to these elements, or consolidated in any appropriate manner to achieve the intended functionality. The various network elements (e.g., switch 14, DHCP server 30, script server 32, configuration server 36, etc.) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, switch 14, DHCP server 30, script server 32, configuration server 36 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some example embodiments, one or more memory elements (e.g., memory elements 18, 42) can store data used for the operations described herein. This includes the memory element being able to store instructions (e.g., software, logic, code, etc.) in non-transitory tangible media, such that the instructions are executed to carry out the activities described in this Specification. A processor can execute any type of instructions associated with the data to achieve the operations detailed herein in this Specification. In one example, processors (e.g., processors 20, 44) could transform an element or an article (e.g., data) from one state or thing to another state or thing. In another example, the activities outlined herein may be implemented with fixed logic or programmable logic (e.g., software/ computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in communication system 10 can include one or more memory elements for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method executed by a hardware processor of a switch in a network environment, comprising:
comparing configuration settings executing on the switch with settings in a configuration file downloaded to the switch from a central configuration server in the network;
identifying a difference between the configuration settings executing on the switch and the settings in the configuration file;
synchronizing the difference by updating the configuration file at the configuration server if a sync up operation is selected; and
synchronizing the difference by updating the configuration settings executing on the switch if a sync down operation is selected.

2. The method of claim 1, wherein the selection for the sync up operation and the sync down operation is specified in a script file downloaded to the switch from a script server.

3. The method of claim 1, wherein the sync up operation comprises updating the configuration file in its entirety at the configuration server.

4. The method of claim 1, wherein the sync up operation comprises updating a template derived output appended to the configuration file at the configuration server.

5. The method of claim 4, wherein configuration file without the appended template derived output is pushed to other switches in the network.

6. The method of claim 1, wherein the sync up operation comprises updating template instance variables feeding into the configuration file at the configuration server.

7. The method of claim 1, wherein the sync up operation comprises updating a template used to generate the configuration file at the configuration server.

8. The method of claim 7, further comprising generating the template based on the configuration settings executing on the switch.

9. The method of claim 1, wherein the updated configuration file according to the sync up operation is pushed to other switches in the network environment.

10. The method of claim 1, wherein the comparing is performed periodically according to a predetermined schedule.

11. One or more non-transitory tangible media that includes instructions for execution, which when executed by a processor of a switch, is operable to perform operations comprising:
comparing configuration settings executing on the switch with settings in a configuration file downloaded to the switch from a central configuration server in the network;
identifying a difference between the configuration settings executing on the switch and the settings in the configuration file;
synchronizing the difference by updating the configuration file at the configuration server if a sync up operation is selected; and
synchronizing the difference by updating the configuration settings executing on the switch if a sync down operation is selected.

12. The media of claim 11, wherein the sync up operation comprises updating the configuration file in its entirety at the configuration server.

13. The media of claim 11, wherein the sync up operation comprises updating a template derived output appended to the configuration file at the configuration server.

14. The media of claim 11, wherein the sync up operation comprises updating template instance variables feeding into the configuration file at the configuration server.

15. The media of claim 11, wherein the sync up operation comprises updating a template used to generate the configuration file at the configuration server.

16. An apparatus, comprising:
a memory element for storing data; and
a processor operable to execute instructions associated with the data, wherein the processor and the memory element cooperate, such that the apparatus is configured for:
comparing configuration settings executing on the apparatus with settings in a configuration file downloaded to the apparatus from a central configuration server in the network;
identifying a difference between the configuration settings executing on the apparatus and the settings in the configuration file;
synchronizing the difference by updating the configuration file at the configuration server if a sync up operation is selected; and
synchronizing the difference by updating the configuration settings executing on the apparatus if a sync down operation is selected.

17. The apparatus of claim 16, wherein the sync up operation comprises updating the configuration file in its entirety at the configuration server.

18. The apparatus of claim 16, wherein the sync up operation comprises updating a template derived output appended to the configuration file at the configuration server.

19. The apparatus of claim 16, wherein the sync up operation comprises updating template instance variables feeding into the configuration file at the configuration server.

20. The apparatus of claim 16, wherein the sync up operation comprises updating a template used to generate the configuration file at the configuration server.
